(19) United States
(12) Patent Application Publication
(10) Pub. No.: US 2004/0078497 A1
(43) Pub. Date: Apr. 22, 2004

(54) Method and apparatus for detecting configuration change

(76) Inventors: Rajeev K. Nalawadi, Folsom, CA (US); Victor M. Munoz, Orangevale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/273,003

(22) Filed: Oct. 17, 2002

(51) Int. Cl. G06F 3/00

(52) U.S. Cl. 710/8

(57) ABSTRACT

Embodiments of the present invention provide for a pre-operating system (OS) routine that facilitates detection of configuration changes in the system. In particular, the pre-OS routine stores a dynamic configuration list of devices, which is accessed when a configuration change, such as adding or removing a device on the platform, is detected. An authentication routine is enforced prior to giving the user access to resources on the platform. Unauthorized access to the platform is prohibited.

### BACKGROUND

Computers have become products highly valued by consumers. Of major concern, however, is that computers are vulnerable to theft due to their commercial value and their exposure to insecure environments. Conventional security mechanisms are vulnerable to component or device replacement since it is difficult to provide a protected environment for execution of code and for manipulation of data. For example, one type of conventional security mechanism involves the use of password software, which is normally executed after a host processor of the computer has been powered-up and has already fetched macro-instructions from Basic Input/Output System (BIOS) code residing in a Read Only Memory (ROM) device and after the operating system is started.

More specifically, during a normal power-on reset, a host processor of a conventional computer automatically jumps to a predetermined hardwired address. This address is a predetermined reset vector that is mapped to a ROM device containing the BIOS code. As a result, the host processor performs instruction fetches of BIOS code that usually prompts the computer to perform the following operations: (i) initialize its electronic hardware; (ii) initialize its peripheral devices; and (iii) boot its Operating System.

Operating systems, such as the Windows operating system, are typically “open” systems in that they are adaptable to different computer systems and are adaptable to changing hardware on any given computer system. At least, in part, due to this openness, it takes a considerable amount of time for the operating system to start up. To some users, this delay may be an annoyance and, in some instances, the start up process may interfere with the way a system operates. Users also desire quick initiation of program operations. Initially, when the computer turns on, it would be desirable to begin operations as quickly as possible.

Additionally, where a platform is stolen or some components are being replaced, it is desirable that the system be rendered usable only after some user authentication has occurred to verify that the individual entities in the platform are being changed by an authorized user of the platform.

### BRIEF DESCRIPTION OF THE DRAWINGS

FIG. 1 illustrates a functional block diagram of an embodiment of an exemplary computer system embodying the present invention.

FIG. 2 illustrates a flow diagram of an embodiment of a routine for saving a configuration list of devices for the initial boot is illustrated.

FIG. 3 illustrates a flow diagram of an embodiment of a routine for verifying addition and/or removal of new devices in the configuration device list is illustrated.

### DETAILED DESCRIPTION

In the following description, numerous specific details are set forth such as specific memory configurations, address ranges, protection schemes, etc., in order to provide a more thorough understanding of the present invention. It will be apparent, however, to one skilled in the art, that the present invention may be practiced without these specific details. In other instances, well known apparatus and steps have not been described in detail in order to avoid obscuring the invention.

Embodiments of the present invention provide for a pre-operating system (OS) routine that facilitates detection of configuration changes in the system. In particular, the pre-OS routine stores a dynamic configuration list of devices, which is accessed when a configuration change, such as adding or removing a device on the platform, is detected. An authentication routine is thus enforced prior to giving the user access to resources on the platform. Unauthorized access to the platform is prohibited.

In particular, a list of known devices on the platform is configured and stored. If a configuration change is detected, such as the addition or removal of a device, it is determined whether the system is being validly accessed. If a configuration change is not detected on the platform, the PCI or other resource entity scanning process can be skipped on every boot, which typically takes a lot of time since it is I/O oriented. This can make the boot process faster and can also enrich the end-user's experience because the OS can be accessed more quickly.

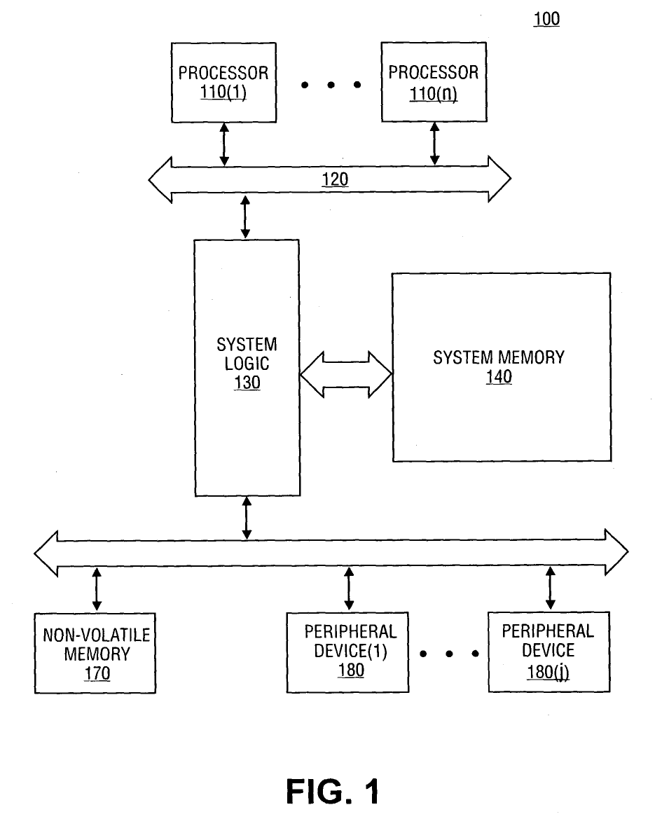

FIG. 1 is a block diagram of one embodiment of a computer system 100 that is suitable for implementing the present invention. The disclosed embodiment of computer system 100 includes one or more processors 110(1)-110(n) (collectively, processors 110) that are coupled to system logic 130 through a processor bus 120. A system memory 140 is coupled to system logic 130 through bus 150. A non-volatile memory 170 and one or more peripheral devices 180(1)-180(j) (collectively, devices 180) are coupled to system logic 130 through peripheral bus 160. System memory 140 may include, but is not limited to conventional memory such as various types of random access memory (“RAM”), e.g., DRAM, VRAM, SRAM, etc., as well as memory-mapped I/O devices.

Bus 160 may be a multiplexed bus such as a Peripheral Component Interconnect (PCI) bus, an Industry Standard Architecture (ISA) bus or any other type of bus architecture. Bus 160 represents, for example, one or more peripheral component interconnect (PCI) buses, industry standard architecture (ISA) buses, extended ISA (EISA) buses, and comparable peripheral buses. It is contemplated that bus 160 includes a single bus (e.g., a PCI bus) as shown, or alternatively, multiple buses coupled together through bridge circuitry. In the later illustrative example, each peripheral device 170.sub.m would be coupled to at least one of the multiple buses.

Non-volatile memory 170 may be a static memory device such as flash memory, read only memory (ROM), erasable programmable read-only memory (EPROM), or electrically erasable programmable read-only memory (EEPROM). Peripheral devices 180 include, for example, a keyboard, mouse or other pointing devices, mass storage devices such as hard drives and digital video discs (DVD), a display, and the like. These devices, together with system logic 130 define the computing platform-iii for system 100. According to one embodiment of the invention, a linked list of a base configuration, which is used for initialization and authentication purposes, is stored in non-volatile memory 170.

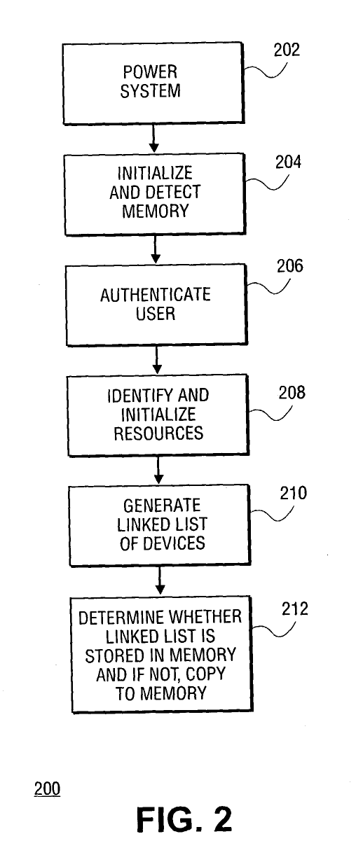

Referring to FIG. 2, a detailed flow diagram of an embodiment 200 of a routine for saving a configuration list of devices for the initial boot is illustrated. The process by which a computer is brought to its operating state from a powered down or powered off state is referred to as bootstrapping. Firmware routines may also be used to reinitialize or reconfigure the computer system following various hardware events and to handle certain platform level events like system interrupts.

The bootstrapping process typically begins with the processor(s) in a computer system and proceeds outward to system level resources. Initially, each processor tests its internal components and interfaces. In multiprocessor systems, a single bootstrap processor (BSP) is usually selected to handle initialization procedures for the system as a whole. These procedures include checking the integrity of memory, identifying and initializing other resources in the computer system, loading the operating system into memory, and initializing the remaining processors. Since volatile memory structures, such as caches and random access memory (RAM), are typically not dependable until later in the boot process the processor implements some of its early firmware routines for the various bootstrapping procedures inside nonvolatile memory.

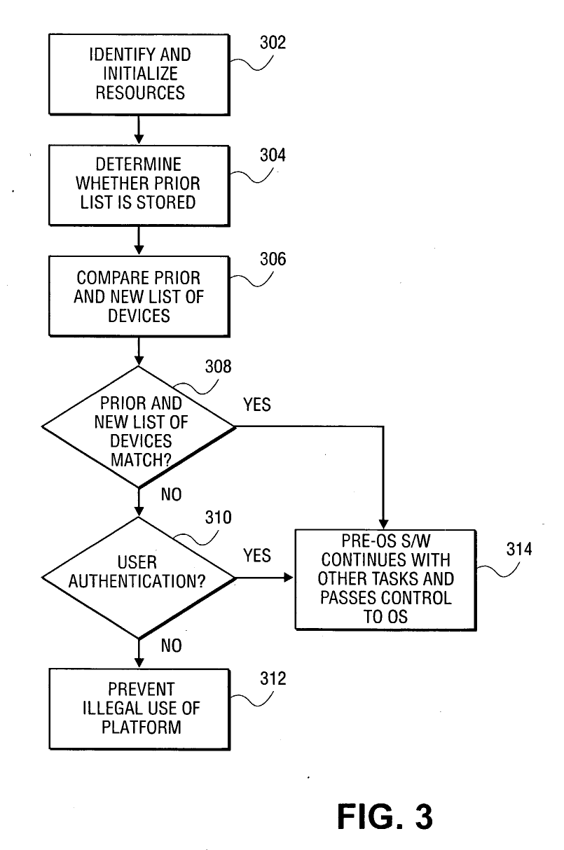

For the disclosed embodiment of the invention, routine 200 coordinates initialization and configuration procedures for system 100 when an initial boot condition is triggered. For example, following certain processor level initialization and checking procedures, routine 200 establishes a linked list of configurations. In one embodiment, the bus is scanned to locate and validate data structure. The linked list of device configurations is stored for future use, as illustrated in FIG. 3 and described below.

In particular, in step 202, the system is powered on.

In step 204, memory is detected and initialized.

In step 206, the user is authenticated by password, such as a keyboard controller based password, hard disk based password or some other advanced mode of password authentication. Once authenticated, execution continues.

In step 208, various resources are identified and initialized. The order of events for initialization indicated in FIG. 2 is not essential to the present invention. Devices can be initialized by scanning various buses, including but not limited to, PCI, ISA, EISA, PCI fabrics, PCI Express, CPU Bus, Memory, and AGP.

For example, non plug and play compatible legacy devices, e.g. resources developed for the IA-32 platform, are initialized. These devices include, but are not limited to some chipset components, super I/O, real time clock (RTC), programmable interval timer (PIT), direct memory access (DMA) and I/O Advanced Programmable interrupt controller (IOAPIC). This creates runtime code tables and runs Advanced Configuration and Power Interface (ACPI) INIT. In a typical implementation, routine scans legacy firmware in non-volatile memory and copies parts of it to system memory during boot operations. Loading legacy into system memory allows firmware to initialize selected entries in data structure and create an environment in which legacy routines may operate.

Selected PCI compatible devices are also detected initialized. In a typical implementation, the PCI bus is scanned to detect such devices.

Storage devices, including but not limited to Integrated Drive Electronics (IDE), Small Computer Systems Interface (SCSI), Compact Disk Read Only Memory (CDROM), ATAPI Removable Mass Storage Devices (ARMD) (for example, zip drives, optical drives and so forth) and network devices, are also detected and initialized.

In step 210, a linked list of devices, based upon the devices initialized in step 208, is generated.

In step 212, the pre-OS routine determines whether a linked list of the configuration is stored in memory, such as non-volatile memory, and if one is not present, copies the configuration linked list in memory that is designated for dynamic updates. Non-volatility is advantageous because it allows the computing system to retain its data and code even when power is removed from the computing system. Thus if the system is turned off or if there is a power failure, there is no loss of code or data, including the linked list of the configuration. One example of a nonvolatile memory device is the flash Electrically Erasable Programmable Read-only Memory (flash EEPROM or flash memory). Flash memory can be programmed by the user, and once programmed, the flash memory retains its data until the memory is erased. Electrical erasure of the flash memory erases the contents of the memory of the device in one relatively rapid operation. The flash memory may then be programmed with new code or data.

Referring to FIG. 3, a detailed flow diagram of an embodiment 300 of a routine for verifying addition and/or removal of new devices in the configuration device list is illustrated.

In step 302, similar to step 208 in the initial boot routine, various resources are identified and initialized. The order of events for initialization indicated in FIG. 3 is not essential to the present invention. For example, during the boot process, the bus is scanned and various devices are initialized. Storage devices, such as IDE, SCSI, CDROM, ARMD and network, are initialized. After the plug and play scan process, a linked list of devices in memory as they are found in the scanning process is created.

In step 304, it is determined whether a prior configuration list of devices is stored in memory. If it is, the list is copied into the system memory for comparison purposes (or can be compared between non-volatile memory and system memory).

In step 306, it is determined whether the prior and new configuration lists of devices match. If a prior configuration list of devices is detected, a check is undertaken at a configuration database to determine whether there have been any changes to the present configuration from the past configuration. One way to implement this function is to determine whether the prior and new configuration lists of devices match.

In step 308, if the prior and new configuration lists match, the pre-OS routine continues with the other tasks and passes control to the OS. The use of the base linked list in connection with operating system initiation may begin in certain embodiments, after the DOS (Disk Operating System) boot up has been completed. Embodiments of the invention provide an abbreviated DOS boot up sequence that skips selected operations. For example, the PCI scanning process on every boot may be skipped.

In step 308, if the prior and new configuration lists do not match, the user is asked for authentication (step 310). Authentication can be in the form of a password software or any other means known to one skilled in the art.

In step 312, if the user does not authenticate (i.e. verification negative), the system is placed into a state that prevents illegal use of the platform. The verification sequence can be allowed for a selected number of time, for example, five (5) tries to accommodate for user errors. In a typical implementation, the routine places the system into a state that prevents illegal use of the platform, such as a soft off (S5) sleep state. Even if the user applies power back to the system, the code execution goes to this check-point and re-enters the soft-off state (S5).

In step 314, if the user does properly authenticate (i.e. verification positive) (step 308), or if there is a match between the prior and new configuration lists (step 306), the pre-OS routine continues with the other tasks and eventually passes control to the OS.

Having now described the invention in accordance with the requirements of the patent statutes, those skilled in the art will understand how to make changes and modifications to the present invention to meet their specific requirements or conditions. Such changes and modifications may be made without departing from the scope and spirit of the invention as set forth in the following claims.

What is claimed is:

1. A method of detecting configuration change in a system, comprising:
developing a first set of device configurations prior to activation of an operating system;
storing information about the first set of device configurations;
developing a second set of device configurations prior to activation of the operating system;
determining whether the first and second set of device configurations differ; and
in response to the first and second set of device configurations differing, selectively determining whether the system is validly accessed, prohibiting access to the system in response to the system not being validly accessed and allowing access to the system in response to the system being validly accessed.

2. The method claimed in claim 1, further comprising selectively allowing access to the system in response to the first and second set of device configurations not differing.

3. The method claimed in claim 2, further comprising:
transferring the information about the first set of configurations to system memory;
operating the system from the first set of configurations; and
booting the operating system.

4. The method claimed in claim 2, wherein developing a first set of device configurations prior to activation of an operating system further comprises:
scanning a bus; and
initializing devices found by scanning the bus.

5. The method claimed in claim 4, wherein the devices comprise legacy devices that are not plug and play compatible.

6. The method claimed in claim 4, wherein the devices comprise PCI compatible devices.

7. The method claimed in claim 4, wherein the devices comprise storage devices.

8. The method claimed in claim 2, wherein storing information about the first set of device configurations further comprises:
storing information about the first set of device configurations in non-volatile memory.

9. The method claimed in claim 2, wherein developing a second set of device configurations prior to activation of the operating system further comprises:
scanning bus; and
initializing devices found by scanning bus.

10. The method claimed in claim 2, wherein prohibiting access to the system in response to the system being not validly accessed further comprises:
placing the system into a state that prevents illegal use of the system.

11. A machine readable medium having stored therein a plurality of machine readable instructions executable by a processor to detect configuration changes in a system, comprising:
instructions to develop a first set of device configurations prior to activation of an operating system;
instructions to store information about the first set of device configurations;
instructions to develop a second set of device configurations prior to activation of the operating system;
instructions to determine whether the first and second set of device configurations differ; and
in response to the first and second set of device configurations differing, instructions to selectively determine whether the system is validly accessed, prohibit access to the system in response to the system not being validly accessed and allow access to the system in response to the system being validly accessed.

12. The machine readable medium claimed in claim 11, further comprising instructions to selectively allow access to the system in response to the first and second set of device configurations not differing.

13. The machine readable medium claimed in claim 12, further comprising:
instructions to transfer the information about the first set of configurations to system memory;
instructions to operate the system from the first set of configurations; and
instructions to boot the operating system.

14. The machine readable medium claimed in claim 12, wherein instructions to develop a first set of device configurations prior to activation of an operating system further comprises:
instructions to scan a bus; and
instructions to initialize devices found by scanning the bus.

15. The machine readable medium claimed in claim 14, wherein the devices comprise legacy devices that are not plug and play compatible.

16. The machine readable medium claimed in claim 14, wherein the devices comprise PCI compatible devices.

17. The machine readable medium claimed in claim 14, wherein the devices comprise storage devices.

18. The machine readable medium claimed in claim 12, wherein instructions to store information about the first set of device configurations further comprises:
instructions to store information about the first set of device configurations in non-volatile memory.

19. The machine readable medium claimed in claim 12, wherein instructions to develop a second set of device configurations prior to activation of the operating system further comprises:
instructions to scan bus; and
instructions to initialize devices found by scanning bus.

20. The machine readable medium claimed in claim 12, wherein instructions to prohibit access to the system in response to the system being not validly accessed further comprises:
instructions to place the system into a state that prevents illegal use of the system.

21. A system comprising:
at least one bus;
a non-volatile memory; and
a controller in communication with the non-volatile memory, including a routine to:
develop a first set of device configurations prior to activation of an operating system,
store the first set of device configurations in the non-volatile memory,
develop a second set of device configurations prior to activation of the operating system;
determine whether the first and second set of device configurations differ; and
in response to the first and second set of device configurations differing, selectively determine whether the system is validly accessed, prohibit access to the system in response to the system not being validly accessed and allow access to the system in response to the system being validly accessed.

22. The system claimed in claim 21, wherein the routine selectively allows access to the system in response to the first and second set of device configurations not differing.

23. The system claimed in claim 21, wherein the routine scans the at least one bus to develop a first set of device configurations prior to activation of an operating system.

24. The system claimed in claim 21, wherein the routine scans the at least one bus to develop a first second of device configurations prior to activation of an operating system.
